(19) United States
(12) Patent Application Publication
(10) Pub. No.: US 2012/0104114 A1
(43) Pub. Date: May 3, 2012

(54) SHOWER HEAD THAT CAN TURN COLORS ALONG WITH TEMPERATURE CHANGE

(75) Inventors: Xieheng Zhou, Xiamen (CN); Renzhong Li, Xiamen (CN); Huasong Zhou, Xiamen (CN)

(73) Assignees: XIAMEN SOLEX HIGH-TECH INDUSTRIES CO., LTD., Fujian (CN); HUASONG ZHOU, Fujian (CN); XIAMEN SOLEX HIGH-TECH INDUSTRIES CO., LTD., Fujian (CN)

(21) Appl. No.: 13/381,460

(22) PCT Filed: May 7, 2009
(86) PCT No.: PCT/CN09/71672

§ 371 Date: Dec. 29, 2011

(51) Int. Cl. B67D 7/08

(52) U.S. Cl. 239/71

(57) ABSTRACT

The present invention discloses a shower head that can turn colors along with temperature change. The said shower head that can turn colors along with temperature change comprises a hollow body and a face cover hermetically set at the front end of the hollow body, and the unity or part of the said face cover is color-changing unit used for offering the information of temperature change. The said shower head that can turn colors along with temperature change can directly show whether the temperature of the water that comes out of the shower head is suitable through color, it is convenient and has more fun when taking shower.

### FIELD OF THE INVENTION

The present invention relates to a shower head used in shower, more particularly to a shower head that can directly show the temperature of the water through color.

### BACKGROUND OF THE INVENTION

The ordinary shower head doesn't have the device that is used for showing the outlet temperature; it is needed to test temperature whether it is suitable by hands when adjusting the outlet temperature, which is not convenient and usually makes people scalded or uncomfortable when the water temperature is too high or too low.

According to the problem mentioned above, a shower head that can show the temperature is designed, which takes a temperature detector that is connected to a display screen used for showing the outlet temperature of the shower head through a processing chip into the body of the shower head, the outlet temperature of the shower head can be shown clearly and directly instead of feeling the water temperature by hand. But the structure of the design mentioned above is complicated and it needs to connect a power source.

### SUMMARY OF THE INVENTION

The object of the present invention is to offer a shower head that can turn colors along with temperature change to solve the problem in the prior art. The said shower head that can turn colors along with temperature change can directly show whether the temperature of the water that comes out of the shower head is suitable through color, it is convenient and has more fun when taking shower.

The present invention is achieved according to such principle:

In recent years, people make much account of the reversible thermo-color pigment; the reversible thermo-color pigment is made of electron-transfer organic compound of which the molecular structure can be changed because of the electron transfer in specific temperature so that the color changing is achieved, it is not only bright-colored, but also can achieve the change of state from achromatic to chromogenic or from chromogenic to achromatic.

The present invention takes advantage of the characteristic of the reversible thermo-color pigment. The specific technical proposal is: it comprises a hollow body and a face cover hermetically set at the front end of the hollow body, wherein said the unity or part of the said face cover is color-changing unit used for offering the information of temperature change.

The color-changing unit is generally made of plastic. Because of the low heat-conductive efficiency of the plastic, it is required to set the outlet in the color-changing unit, namely the color-changing unit is color-changing outlet unit. The color-changing outlet unit is made of a kind of plastic particle in which at least one kind of thermal achromatic reversible thermo-color pigment and one kind of ordinary pigment with different color are evenly spread and is formed by injection molding. The color-changing time of the reversible thermo-color pigment in the prior art depends on the thermal energy and the heat-conductive effect, and that is about 5 seconds to 60 seconds. When it is been used, the current comes out of the water outlet in the color-changing outlet unit, and then transfers the temperature to the color-changing unit to make it change color so that the users can directly get the current outlet temperature without hand touch.

Of course, when the chosen thermal achromatic reversible thermo-color pigment is stable in high temperature, it is also available to replace the plastic particle with metal material so that the heat-conductive efficiency is higher.

In the aforementioned shower head that can turn colors along with temperature change, the said color-changing outlet unit is a two-stage color-changing unit that can provide low temperature information and suitable temperature information, the said color-changing outlet is made of a kind of plastic particle in which one kind of thermal achromatic reversible thermo-color pigment and one kind of ordinary pigment with different color are evenly spread and is formed by injection molding. The said low temperature generally means the temperature under 35° C., the said suitable temperature generally means the temperature between 36° C. and 40° C. The said transparent or semitransparent plastic particle can be chosen from polytene, polypropylene, polystyrene, flexible PVC, AS, ABS, silica gel and so on, the quantity of the color-changing pigment is generally 0.3˜3.0% of the weight of the plastic particle. If the color-changing unit is made of the color-changing pigment which has color-changing zone between 36° C. and 40° C. and of which the coloration is cold tone, the color-changing unit is achromatic when the temperature is above 40° C., and turns out to be cold tone when the outlet temperature drops under 36° C.; or if combined with warm tone ordinary pigment based on the said color-changing pigment, the color-changing unit is warm tone when the water temperature is above 40° C., and turn out to be the secondary color of the two color mentioned above.

In the aforementioned shower head that can turn colors along with temperature change, the said color-changing outlet unit is a three-stage color-changing unit that can provide the information of low temperature, suitable temperature and high temperature. The said color-changing outlet unit is made of a kind of plastic particle in which two kinds of thermal achromatic reversible thermo-color pigment and one kind of ordinary pigment with different color are evenly spread and is formed by injection molding. The said low temperature generally means the temperature under 35° C., the said suitable temperature generally means the temperature between 36° C. and 40° C., the said high temperature generally means the temperature above 50° C. If the color-changing unit is made of one kind of color-changing pigment which has color-changing zone between 35° C. and 37° C. and of which the coloration is gentle cold tone and one kind of color-changing pigment which has color-changing zone between 40° C. and 42° C. and of which the coloration is another kind of gentle cold tone, the color-changing unit is secondary color of the two cold tone, namely a strong cold tone when the temperature is under 35° C., it turns out to be gentle cold tone when the outlet temperature is between 37° C. and 40° C., and it turns out to be achromatic when the water temperature is above 42° C. It can also use the ordinary pigment with stronger warm tone to combine with the two color-changing pigments mentioned above. In that case, the color-changing unit turns out to be the secondary color of the strong warm tone and the two cold tones when the water temperature is under 35° C.; it turns out to be gentle warm tone when the water temperature is between 37° C. and 40° C.; it turns out to be strong warm tone to warn the users when the water temperature is above 42° C.

In like manner, the color-changing outlet unit can also be four, five, or even more forms, which is made of a kind of plastic particle in which two kinds of thermal achromatic reversible thermo-color pigment and one kind of ordinary pigment with different color are evenly spread and is formed by injection molding.

In the aforementioned shower head that can turn colors along with temperature change, the said color-changing outlet unit includes at least two color-changing outlet layers, each layer has different color-changing temperature and is respectively made of transparent or semitransparent plastic particle in which different kinds of thermal achromatic reversible thermo-color pigment are evenly spread and is formed by injection molding.

In the aforementioned shower head that can turn colors along with temperature change, the said color-changing outlet unit is set on the surface layer around or in the centre of the face cover, or is set at intervals with the ordinary outlet units, so that it can achieve better visual effects.

In the aforementioned shower head that can turn colors along with temperature change, several different kinds of water outlet are set on the ordinary outlet unit and the color-changing outlet unit, so that the users can have more comfortable experience.

Apart from specializing, the meanings of terminology used here are identical to the meanings understood by the general technician in the technical field that the present invention belongs to. In the same way, all the publication, patent application, patent and other references mentioned here can be inducted to the present invention and to be reference.

After the technical proposal mentioned above being adopted, the present invention creatively offer a shower head that can show whether the present water temperature is too cold, too hot or suitable by using different colors. The present invention can change the color of the color-changing outlet unit directly through the water temperature without additional power rescore or temperature detector. Its structure is simple. It is convenient to use and has more fun when taking shower.

### BRIEF DESCRIPTION OF THE DRAWINGS

FIG. 1 shows the sectional view of the shower heads that can turn colors along with temperature change in the preferred embodiment 1 and 2;

FIG. 2 shows the abridged general view of the shower heads that can turn colors along with temperature change in the preferred embodiment 1 and 2 when they are achromatic;

FIG. 3 shows the abridged general view of the shower heads that can turn colors along with temperature change in the preferred embodiment 1 and 2 when they are chromogenic;

FIG. 4 shows the abridged general view of the shower head that can turn colors along with temperature change in the preferred embodiment 3 when it is chromogenic;

FIG. 5 shows the structure abridged general view of the shower head that can turn colors along with temperature change in the preferred embodiment 5 when it is chromogenic;

Among which, hollow body 1, face cover 2, color-changing outlet unit 3, ordinary unit 4 and color-changing draining mouth 5.

### DESCRIPTION OF THE PREFERRED EMBODIMENTS

With the following description of the drawings and specific embodiments, the invention shall be further described in details:

### Embodiment 1

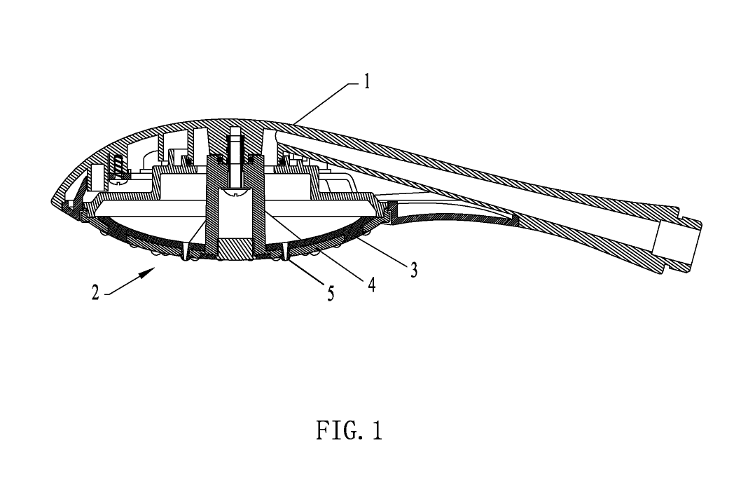

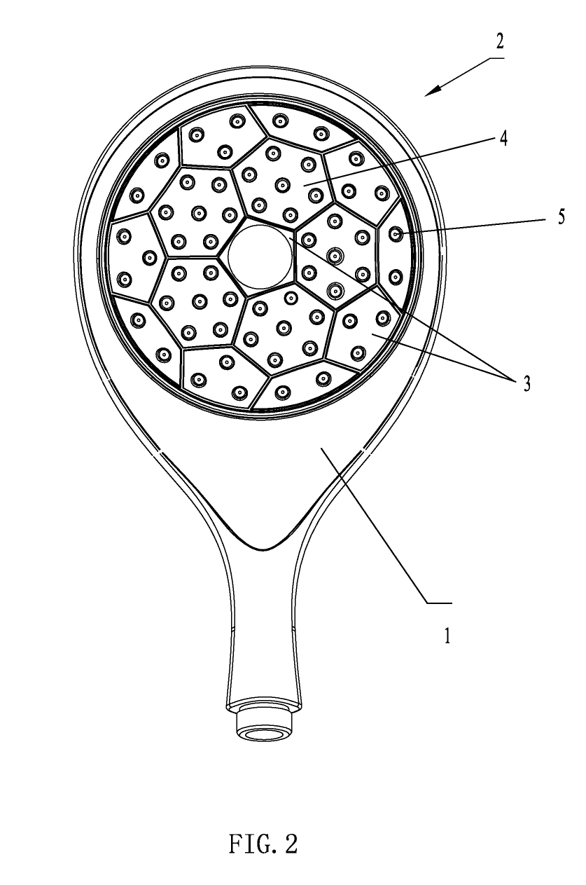

As shown in FIG. 1 and FIG. 2, the shower head that can turn colors along with temperature change comprise a hallow body 1 and a face cover 2. The face cover 2 is hermetically set at the front end of the hollow body 1, the color-changing outlet 3 is fixed to the surface of the face cover 2 with interval to the ordinary unit 4, several color-changing draining mouths 5 is arranged on the ordinary unit 4. The color-changing outlet unit 3 and the color-changing draining mouth 5 are made of a kind of plastic particle in which 1.0% (weight ratio) thermal achromatic reversible thermo-color pigment (color-changing zone: 36° C.˜40° C., coloration is peacock green) and 99.0% (weight ratio) ordinary rose red pigment are evenly spread and is formed by injection molding.

When the water temperature is under 36° C., the reversible thermo-color pigment is peacock green (without color changing), at the same time, the color-changing outlet unit is the secondary color of rose red and peacock green, namely blue grey;

When the water temperature is above 40° C., the reversible thermo-color pigment is achromatic (the color is gone), the color-changing outlet unit is the essential color, namely rose red.

It means the water temperature is under 36° C. when the color-changing outlet unit 3 and the draining mouth 5 of the shower head are blue gray, and means the water temperature is above 40° C. when they are rose red; and means the water temperature is suitable when they show the intermediate color of blue grey and rose red.

### Embodiment 2

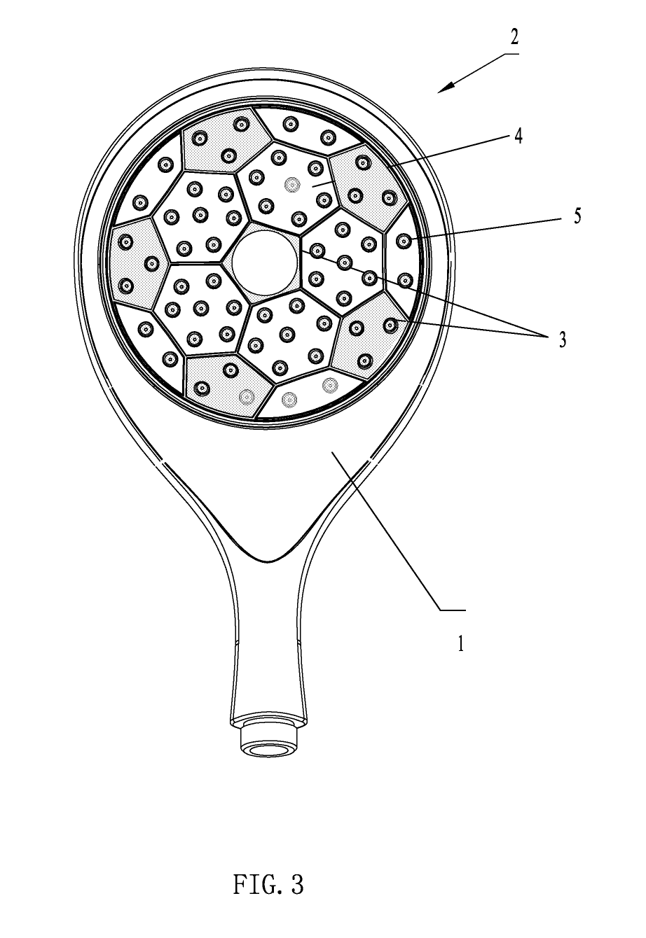

As shown in FIG. 1, FIG. 2 and FIG. 3, the differences between embodiment 1 and embodiment 2 are: in embodiment 2, The color-changing outlet unit 3 and the color-changing draining mouth 5 are made of a kind of plastic particle in which 1.0% (weight ratio) the first thermal achromatic reversible thermo-color pigment (color-changing zone: 35° C.˜37° C., coloration is chinese verdure), 1.0% (weight ratio) the second thermal achromatic reversible thermo-color pigment (color-changing zone: 40° C.˜42° C., coloration is rose red) and 98% (weight ratio) ordinary yellow pigment are evenly spread and is formed by injection molding.

When the water temperature is under 35° C., the color-changing outlet unit shows the secondary color of the chinese verdure, rose red and yellow, namely dark blue;

When the water temperature is between 37° C. and 40° C., the first thermal achromatic reversible thermo-color pigment turns to be achromatic, at the same time, the color-changing outlet unit shows the secondary color of rose red and yellow, namely deep red;

When the water temperature is above 42° C., the first and the second thermal achromatic reversible thermo-color pigment turn to be achromatic, at the same time, the color-changing outlet unit shows the essential color, namely yellow

### Embodiment 3

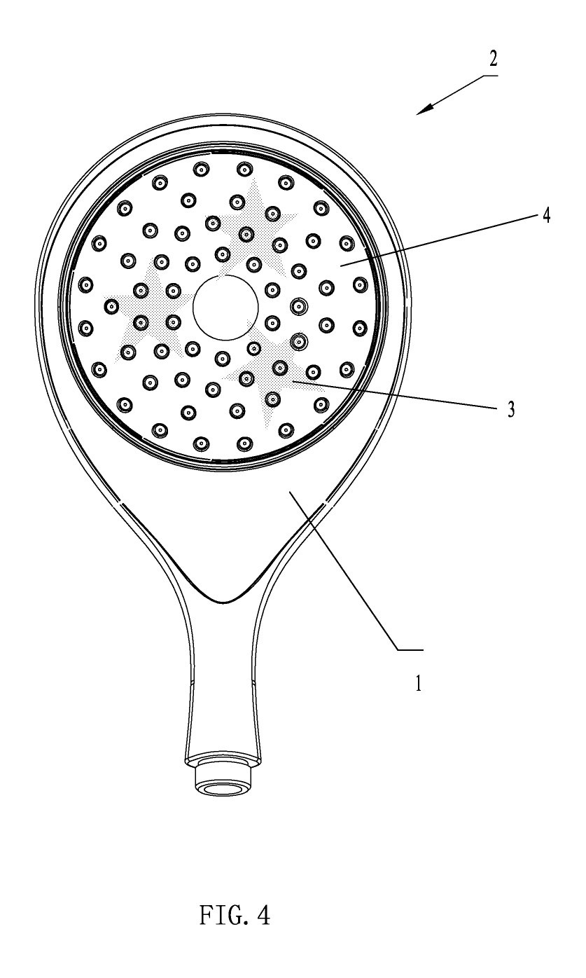

As shown in FIG. 4, the shower head that can turn colors along with temperature change comprise a hallow body 1 and a face cover 2. The face cover 2 is hermetically set at the front end of the hollow body 1, three star-like color-changing outlet unit 3 is fixed on the surface of the face cover 2 irregularly.

In other different embodiments of the present invention, the star-like pattern can be replaced by other pattern, such as the smile face of kids, flowers, sun, moon and other cartoon pattern that can make people happy.

### Embodiment 4

The differences between embodiment 1 and embodiment 2 are: the color-changing outlet unit can be fixed on the surface of the face cover 2 by assembly. The color-changing outlet unit 4 could be replaced in time when the thermal achromatic reversible thermo-color pigment reach its service life, namely the color-changing ability is gone or the sensitivity is low.

### Embodiment 5

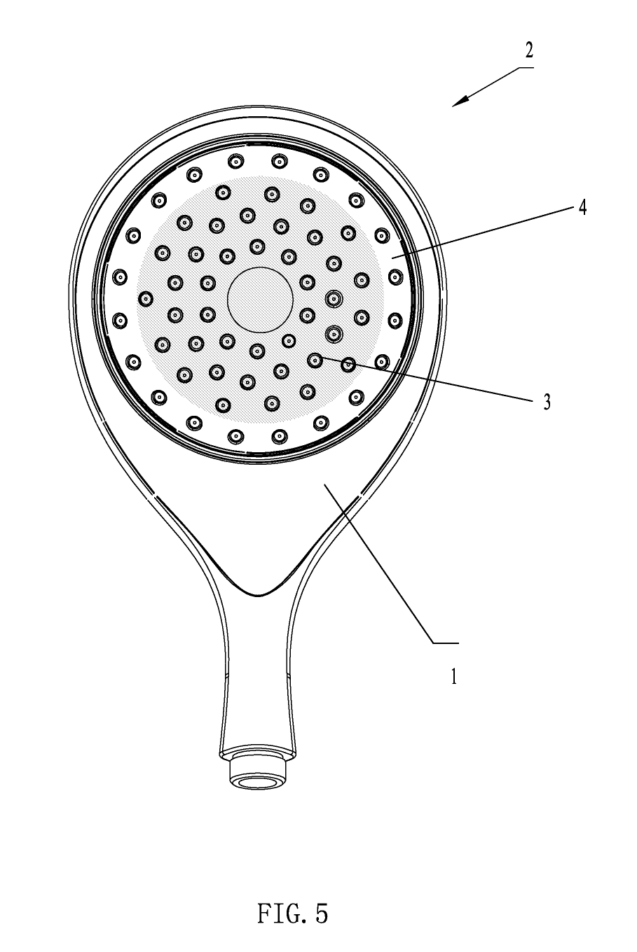

As shown in FIG. 5, the shower head that can turn colors along with temperature change comprise a hallow body 1 and a face cover 2. The face cover 2 is hermetically set at the front end of the hollow body 1; the color-changing outlet 3 is fixed to the center of the surface of the face cover 2.

Seven layers of transparent color-changing outlet unit are formed respectively and independently with different color-changing temperature, and are fixed on the surface of the face cover 2 in turn by cohesion so that the color-changing outlet unit 3 that is made of a kind of transparent or semitransparent plastic particle in which several kinds of thermal achromatic reversible thermo-color pigment and one kind of ordinary pigment with different color are evenly spread and is formed by injection molding is constructed.

The properties of the thermal achromatic reversible thermo-color pigments distributed in the 7 transparent color-changing outlet layers from surface layer to basal layer in turn are numbered up:

The first color-changing outlet layer (color-changing zone: 10° C.˜16° C., coloration is dark blue), The second color-changing outlet layer (color-changing zone: 20° C.˜26° C., coloration is blue), The third color-changing outlet layer (color-changing zone: 30° C.˜36° C., coloration is light blue), The fourth color-changing outlet layer (color-changing zone: 40° C.˜46° C., coloration is white), The fifth color-changing outlet layer (color-changing zone: 50° C.˜56° C., coloration is pink), The sixth color-changing outlet layer (color-changing zone: 60° C.˜66° C., coloration is red), The seventh color-changing outlet layer (color-changing zone: 70° C.˜76° C., coloration is bright red).

When the water temperature is under 10° C., the color-changing outlet unit shows the color of the first color-changing outlet layer, namely dark blue;

When the water temperature is between 16° C. and 20° C., the first color-changing outlet layer is transparent, at the same time, the color-changing outlet unit show the color of the second color-changing outlet layer, namely blue;

When the water temperature is between 26° C. and 30° C., the first and the second color-changing outlet layer are transparent, at the same time, the color-changing outlet unit show the color of the third color-changing outlet layer, namely light blue;

When the water temperature is between 36° C. and 40° C., the first, the second and the third color-changing outlet layer are transparent, at the same time, the color-changing outlet unit show the color of the fourth color-changing outlet layer, namely white; . . . the rest may be deduced by analogy, as the outlet temperature is increasing, the color of the color-changing outlet changes from cold tone to warm tone, and it shows directly whether the present outlet temperature is too cold, too hot or suitable.

According to their properties, there are two kinds of reversible thermo-color pigments: 1 thermal-achromatic type: it shows color when the temperature is low and turns to be achromatic when the temperature rises to the setting value, its color-changing zone is −20˜80° C.; 2 thermal-development type: it is achromatic when the temperature is low and turns to show color when the temperature rises to the setting value, its color-changing zone is 60˜65° C. The reversible thermo-color pigments in the prior art have fifteen fundamental colors: dark green, medium green, peacock green, grass green, black, sea blue, royal blue, golden yellow, bright red, rose red, brilliant yellow, brown black, peach bloom and orange red.

The following color schemes can be chosen to get more kinds of color: 1 the combination of different reversible thermo-color pigments, for example: the ratio of which the black pigment and the royal blue pigment is 1:1 can get the navy blue pigment; the ratio of which the rose red pigment and the peacock green pigment is 1:1 can get the shadow blue pigment; the ratio of which the royal blue pigment and the peacock green pigment is 1:1 can get the dark blue pigment, and so on; 2 the combination of the reversible thermo-color pigment and the ordinary pigment, for example: the combination of the rose red thermo-color pigment and the ordinary sky blue pigment can get the pigment with sky blue procrypsis and blue violet coloration; the combination of the dark green thermo-color pigment and the ordinary bright red pigment can get the pigment with bright red procrypsis and black coloration; the combination of the peacock green thermo-color pigment and the ordinary yellow pigment can get the pigment with yellow procrypsis and emerald green coloration, and so on.

In addition, the color-changing temperature of the thermo-color pigment is not just a temperature point, but a temperature zone of which the extent is 4˜6° C., and is just 2˜3° C. in some pigments with higher color-changing accuracy. This property makes sure that the reversible color change can show the present temperature with comparatively accuracy.

### THE INDUSTRIAL APPLICABILITY

According to the property of the reversible thermo-color pigment, the present invention creatively offers a shower head that can show whether the present water temperature is too cold, too hot or suitable by using different colors. The present invention can change the color of the color-changing outlet unit directly through the water temperature without additional power resource and temperature detector. Its structure is simple. It is convenient to use and has more fun when taking shower.

1. Shower head that can turn colors along with temperature change, it comprises a hollow body and a face cover hermetically set at the front end of the hollow body, wherein said the unity or part of the said face cover is color-changing unit used for offering the information of temperature change, and the water temperature in the body of the shower head is transferred to the color-changing unit and makes it change color, the color change of the color-changing unit offers the information of the outlet temperature.

2. The shower head that can turn colors along with temperature change according to claim 1, wherein said color-changing unit is color-changing outlet unit, when water comes out of the shower head, the current comes out of the water outlet in the color-changing outlet unit, and then transfers the temperature to the color-changing unit to make it change color, the color change of the color-changing outlet unit offers the information of the outlet temperature.

3. The shower head that can turn colors along with temperature change according to claim 2, wherein said color-changing outlet unit is made of a kind of plastic particle in which one kind of thermal achromatic reversible thermo-color pigment and one kind of ordinary pigment with different color are evenly spread and is formed by injection molding; when the temperature is low, the color is the secondary color of the said thermal achromatic reversible thermo-color pigment and the said ordinary pigment; when the temperature is high, the said thermal achromatic reversible thermo-color pigment is decolorized, and the color-changing outlet unit is the color of the ordinary pigment; when the temperature is suitable, the color is the intermediate color of the said thermal achromatic reversible thermo-color pigment and the said ordinary pigment.

4. The shower head that can turn colors along with temperature change according to claim 2, wherein said color-changing outlet unit is made of a kind of plastic particle in which two kinds of thermal achromatic reversible thermo-color pigment and one kind of ordinary pigment with different color are evenly spread and is formed by injection molding; the said color-changing outlet unit is a three-stage color-changing unit that can provide the information of low temperature, suitable temperature and high temperature.

5. The shower head that can turn colors along with temperature change according to claim 2, wherein said color-changing outlet unit includes at least two color-changing outlet layers, each layer has different color-changing temperature and is respectively made of transparent or semitransparent plastic particle in which different kinds of thermal achromatic reversible thermo-color pigment are evenly spread and is formed by injection molding.

6. The shower head that can turn colors along with temperature change according to claim 2, wherein said color-changing outlet unit is set on the surface layer around or in the centre of the face cover, or is set between two ordinary outlet units.

7. The shower head that can turn colors along with temperature change according to claim 6, wherein several different kinds of water outlet are set on the ordinary outlet unit and the color-changing outlet unit.

8. The shower head that can turn colors along with temperature change according to claim 3, wherein said color-changing outlet unit is set on the surface layer around or in the centre of the face cover, or is set between two ordinary outlet units.

9. The shower head that can turn colors along with temperature change according to claim 4, wherein said color-changing outlet unit is set on the surface layer around or in the centre of the face cover, or is set between two ordinary outlet units.

10. The shower head that can turn colors along with temperature change according to claim 5, wherein said color-changing outlet unit is set on the surface layer around or in the centre of the face cover, or is set between two ordinary outlet units.

11. The shower head that can turn colors along with temperature change according to claim 8, wherein several different kinds of water outlet are set on the ordinary outlet unit and the color-changing outlet unit.

12. The shower head that can turn colors along with temperature change according to claim 9, wherein several different kinds of water outlet are set on the ordinary outlet unit and the color-changing outlet unit.

13. The shower head that can turn colors along with temperature change according to claim 10, wherein several different kinds of water outlet are set on the ordinary outlet unit and the color-changing outlet unit.
